(19) United States
(12) Patent Application Publication
(10) Pub. No.: US 2007/0100755 A1
(43) Pub. Date: May 3, 2007

(54) Identification of protected content items by means of icons

(75) Inventors: Erwin Kragt, Breda (NL); Petrus Johannes Lenoir, Hertogenbosch (NL); Franciscus Lucas Antonius Johannes Kamperman, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/561,998

(22) PCT Filed: Jun. 28, 2004
(86) PCT No.: PCT/IB04/51038

§ 371 Date: Dec. 23, 2005

(30) Foreign Application Priority Data
Jun. 30, 2003 (US) 60483774

(51) Int. Cl. G06Q 99/00

(52) U.S. Cl. 705/51

(57) ABSTRACT

When displaying display items representing a set of content items including items protected by a number of different digital rights management systems on the display of a content access system, the set of display items representing the content items includes icons associated at least with the display items for each protected content item. The icons indicate whether a respective content item is protected by a digital rights management system and, if so, which digital rights management system is employed to protect the respective content item, whether an executable digital rights management module for accessing the respective protected content item is accessible to the user, and whether the user is entitled to access the respective protected content item. The icons also serve as user controls either for accessing information regarding acquisition of, or initiating actual acquisition of, the digital rights management module, access rights, or both.

The present invention relates generally to display interfaces for content rendering and/or recording devices and, more particularly, to icons for identifying digital rights management protected content accessibility and entitlements within display interfaces for content rendering and/or recording devices.

Various digital rights management (DRM) systems are available or have been proposed to restrict access to digital audio or digital audio/video (hereinafter simply “video”) content. Authorized domains for enterprise or personal use and enterprise or in-home networks may store a substantial amount of such content, originating from the content provider (owner or distributor), co-workers, family members or acquaintances. Often the digital rights management system is implemented in the form of a downloadable module for controlling decryption and/or rendering of the content item.

However, different content items accessible to a given user may be protected by different digital rights management systems that are not interoperable. The digital rights management module controlling access to a particular content item may not be present within the authorized domain or otherwise available to the user for execution. Even though the appropriate digital rights management module may be available for free retrieval via the Internet, the user may have no way of determining the correct module to seek (e.g., the file extension may not be registered on the user's system) from the item alone. Moreover, even if the digital rights management module for a particular content item is accessible to the user, that user may not be entitled to listen to or view the content item, and may not be able to determine from the item either that lack of entitlement is the obstacle to play-back or how to acquire rights to listen to or view the content item (e.g., by purchasing a subscription).

There is, therefore, a need in the art for improved identification of, and conveyance of information regarding, protected content items.

To address the above-discussed deficiencies of the prior art, it is a primary object of the present invention to provide, for use in a content access system displaying a set of display items representing content items including items protected by a number of different digital rights management systems, a display of the display items that includes icons associated at least with the display item for each protected content item. The icons indicate whether a respective content item is protected by a digital rights management system and, if so, which digital rights management system is employed to protect the respective content item, whether an executable digital rights management module for accessing the respective protected content item is accessible to the user, and whether the user is entitled to access the respective protected content item. The icons also serve as user controls either for accessing information regarding acquisition of, or initiating actual acquisition of, the digital rights management module, access rights, or both.

Other technical advantages will be readily apparent to one skilled in the art from the following figures, description, and claims.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

For a more complete understanding of the present invention, and the advantages thereof, reference is now made to the following descriptions taken in conjunction with the accompanying drawings, wherein like numbers designate like objects, and in which:

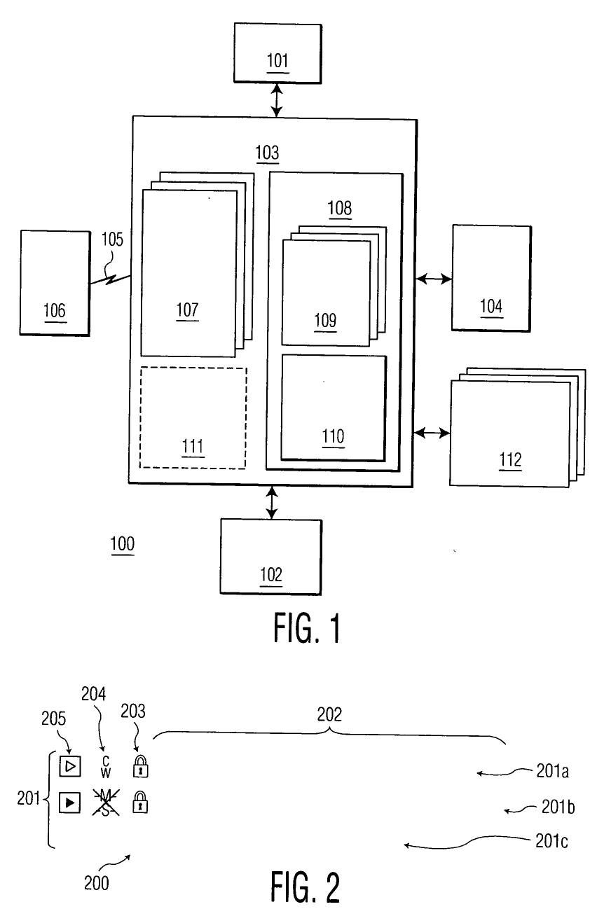

FIG. 1 depicts a content access system within which protected content items are identified and information relating to such items is conveyed by icons according to one embodiment of the present invention;

FIG. 2 illustrates a portion of user interface display content for a content access system within which protected content items are identified and information relating to such items is conveyed by icons according to one embodiment of the present invention;

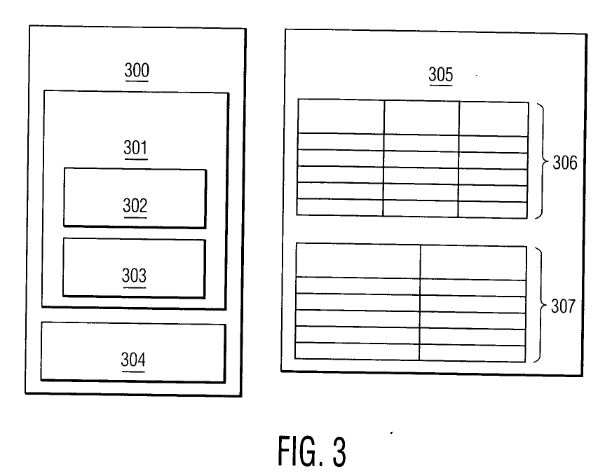

FIG. 3 is a block diagram of data structures facilitating identification of protected content items and conveyance of information relating to such items by icons according to one embodiment of the present invention; and

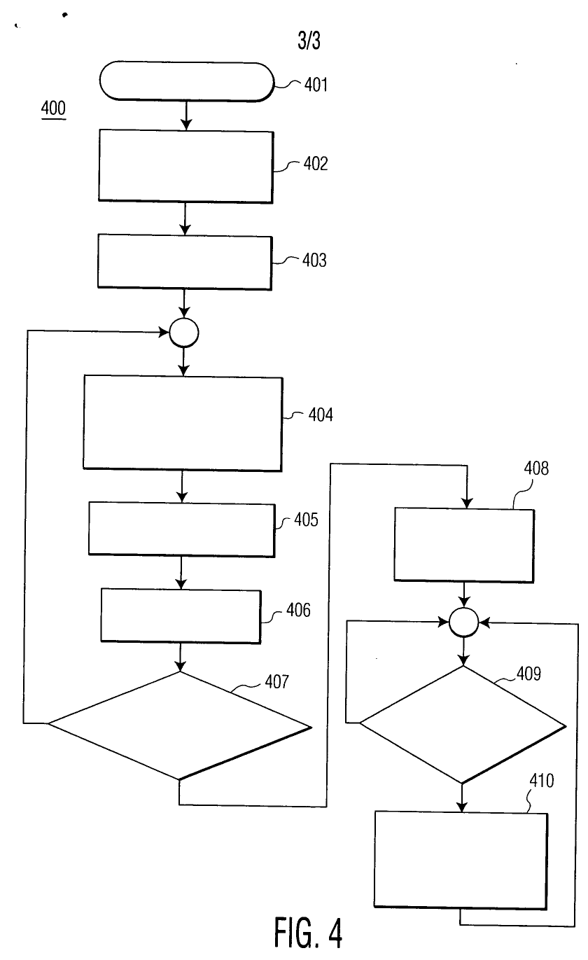

FIG. 4 is a high level flow chart for a process of generating user interface display content for a content access system within which protected content items are identified and information relating to such items is conveyed by icons according to one embodiment of the present invention.

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a content access system within which protected content items are identified and information relating to such items is conveyed by icons according to one embodiment of the present invention. Content access system 100 includes a user interface display 101 and one or more user input devices 102 (e.g., mouse or other cursor location control device, keyboard/buttons/remote control, stylus, dial, etc.) both communicably coupled to a control sub-system 103. Display 101 and user input devices 102 are not necessarily separate, since user input may be enabled by, for example, a touch screen or contact of a stylus with the display.

Control sub-system 103 may include a processor or controller (not shown) together with one or more software systems, such as a basic input-output system (BIOS), operating system (OS), and/or embedded control software (also not shown). Control sub-system 103 is also communicably coupled: to local data storage medium(s) 104, such as a hard disk drive, a compact disk (CD) and/or compact disk read only memory (CD-ROM) drive, and/or a digital versatile disk (DVD) drive; via communications link 105 such as a network or Internet connection to a remote data storage system 106, which may be a file server or a HyperText Transfer Protocol (HTTP) server; or to both.

Those skilled in the art will recognize that the full construction and operation of a content access system is not depicted or described herein. Instead, for simplicity and clarity, only so much of a content access system as is unique to the present invention or necessary for an understanding of the present invention is depicted and described herein. Content access system 100 may be, for example, a set-top box, a personal computer, a CD or DVD player and/or recorder, a satellite or terrestrial television receiver unit, a portable audio (e.g., MP3) or video playback device, a personal digital assistant (PDA), a mobile telephone, or some combination of the functionality of any of such devices.

In the present invention, content access system 100 includes at least one of: a content rendering/editing program 107, such as a DVD or other video player application, an audio media player application, or a document editor; and a browser application 108 including content rendering modules 109 for playing video or audio files and/or content access and management functionality 110. Content access system 100 may alternatively include separate content access and/or management functionality 111 capable either of operating independently of browser application 108, of operating with browser application 108 as a user interface thereof, or both. Content access system 100 is also communicably coupled to, or alternatively contains therein, one or more digital rights management system module(s) 112. The digital rights management system module(s) 112 may be any permutation of local or remote hardware and/or software. A particular digital rights management module may, for instance, be embodied in a smart card or other separate device from content access system 100. In addition, the digital rights management system module(s) 112 may be partially or fully integrated within, or operable as a “plug-in” to, one or more of content rendering/editing program 107 and/or content rendering modules 109.

FIG. 2 illustrates a portion of user interface display content for a content access system within which protected content items are identified and information relating to such items is conveyed by icons according to one embodiment of the present invention. Display content portion 200 is generated by one of content rendering program(s) 107, browser 108 and either content rendering module(s) 109 or content management functionality 110, or content management functionality 111 executing within content access system 100 and displayed on display 101. Display content portion 200 includes, in the exemplary embodiment, a tabular listing 201 of a set of content items 201a-201c, with three content items being displayed in the example shown. The list 201 contains titles or file names 202 for content items accessible to the user of content access system 100, although each content item might alternatively be represented graphically or by a combination of text and graphics. The content items may contain audio, video, or text content or some combination thereof.

While viewing or browsing set 201 of content items accessible to the user (i.e., located within the “authorized domain,” the set of storage devices or systems that the user may permissibly access), the user of content access system 100 may want a clear indication of attributes of the content items, such as content type, size, generation date/time, and content protection system, if any. With respect to content items protected by digital rights management systems, the user may wish to know: if the content item is protected by a digital rights management system; which digital rights management system is employed for the content item, if protected; if a digital rights management module enabling access to the content item is available to the user for execution from anywhere within the authorized domain; if the specific digital rights management module is not available to the user, how to obtain that digital rights management module; whether the user is entitled to access the content item; and, if the user is not entitled to access the content item, how to obtain rights to access the content item.

In the present invention, digital rights management protection of content items is identified, and the information described above regarding such protection is conveyed, through icons 203-205 associated with items 201a-201c within set 201. Each icon may be a graphic image (either fixed or varying), text, or a combination of both. The association of particular icons with a specific item 201a-201c is indicated by proximity and position within the tabular listing 201, or otherwise for other display formats of the set of accessible content items. For example, in a display format in which all accessible content items are represented by a “scrollable” array of graphical images and associated text, the icons 203-205 may appear in a “pop-up” dialog box when the graphical image (or image portion) representing an item is highlighted or when a cursor “hovers” over the image. Alternatively, the icons 203-205 may be displayed as satellite icons, smaller sized icons positioned close to, and optionally at a predetermined position such as near the upper right edge of, the graphical image representing the corresponding content item.

In an exemplary embodiment, icons 203 having the appearance of a lock associated with particular content items indicate that the respective content item is protected by a digital rights management system. The absence of such an icon indicates that the respective content item is not protected. Items 201a and 201b in the example shown are indicated as being protected while item 201c is indicated as not being protected.

Icons 204 associated with each protected content item 201a-201b identify the particular digital rights management system employed to protect the respective content item. In the example shown, two different digital rights management systems are identified, one in association with content item 201a and a different one in association with content item 201b. Graphical attributes of icons 204 may be employed to indicate whether the digital rights management module necessary to access the protected content item 201a-201b is available to the user. Thus, the “X” portion of the icon 204 associated with item 201b indicates that the digital rights management module necessary to access content item 201b is not available to the user. Availability of the appropriate digital rights management module may be conveyed by a particular icon, while non-availability is indicated by the same icon with a superimposed negation image such as a red “X” or circle with a diagonal slash.

Icons 205 associated with each protected content item 201a-201b indicate whether the current user is entitled to access the respective content item. In the example shown, a graphical image of a conventional “play” button (i.e., a rectangle with a right-pointing triangle therein) is employed for icons 205, with variation of the icon characteristics, such as a green or shaded triangle rather than a red or unshaded triangle, indicating whether the current user has rights to access the respective content item 201a-201b. In the example shown, the user is indicated to have rights to access item 201b but not item 201a.

For each of icons 203-205, variations of the exemplary embodiment may be employed to indicate the information described. Each of icons 203 and 205 may indicate presence or absence of protection or entitlements by presence or absence of the corresponding icon, by varying attributes such as color or shading of the icon, by displaying a ghost or phantom image of the icon versus a “full” image of the icon, or by selectively superimposing a negation image (e.g., a red “X” or circle with diagonal slash) over the icon. Alternatively, a columnar heading or header row at the top of list 201 may be supplied to define the information conveyed, with checkmarks associated with items 201a-201c as necessary. Icon 204 may have negation images superimposed over an image or logo representing a particular digital rights management system as described above, or may display either a phantom image or the full image.

Icons 203 and 204 are preferably also user controls, such that selection of the icon (actuating a user control while the icon is highlighted or otherwise distinguished from remaining icons in the display, or positioning a cursor over the icon or otherwise highlighting the item, then actuating a user control such as a mouse button or a “Select” key) display of information. For example, actuating icon 203 may trigger display of information regarding acquisition of the appropriate digital rights management module (e.g., by purchase and download from an Internet server, by purchase in the form of a smart card from a local retail establishment, etc.), while actuating on icon 204 may trigger display of information on acquiring access rights (e.g., by purchasing or registering for a copy or a subscription). Such information may be displayed in a “pop-up” dialog display, by “jumping” to a page of display content containing the information, or by displaying the information in a separate “window” or display area opened or created for that purpose. In addition, in certain embodiments icon 203 may indicate merely the presence or absence of, for instance, a smart card containing the requisite digital rights management module.

In one embodiment, the display triggered by actuating icon 203 may simply contain a description and link that may be selectively employed to initiate download of a digital rights management module, may directly load a page of display content from which such download may be initiated, or may actually initiate such a download. Similarly, the display triggered by actuating on icon 204 may simply contain a description and link that may be selectively employed to acquire access rights or may directly load a page of display content that may be employed to acquire such rights. Optionally, a separate display describing the nature of the icon and the action triggered by actuating the user control represented by the icon may be displayed in a pop-up display when an icon is highlighted or a cursor hovers over any of the icons.

Icons 203 and 204 may be effectively merged, with protection indicated simply by presence of an icon 204 identifying use of a particular digital rights management system for a particular content item, with absence of any such icon tacitly indicating the absence of any such content protection for an associated item. Optionally, icons 204 and 205 may also be effectively merged, with a negative indicator (such as a superimposed negation image) indicating either (a) lack of access to the appropriate digital rights management module or (b) lack of access rights by the current user. Since icons 204 and 205 are also user controls for triggering download of the appropriate digital rights management module or acquisition of necessary access rights, an un-negated (i.e., “normal” or full, or without superimposed negation image) icon image may indicate both presence of the necessary digital rights management module and access rights for the current user, while a negated icon image (i.e., phantom or differently shaded) icon image or superimposed negation image may indicate either absence of the appropriate digital rights management system module, absence of access rights, or both. Actuating the merged icon may trigger download of the requisite digital rights management module, acquisition of access rights, or both, as warranted for a particular content item. In this manner, icons 203-205 may optionally be merged into a single icon and user control.

FIG. 3 is a block diagram of data structures facilitating identification of protected content items and conveyance of information relating to such items by icons according to one embodiment of the present invention. In one embodiment of the present invention, each protected content item 300 has embedded therein a field 301 identifying the digital rights management system protecting that content item. Field 301, or a separate field within the content item 300, may optionally contain the icon(s) 302 to be displayed in association with the protected content item as part of display 201 depending on availability of an executable instance of the appropriate digital rights management module and/or access rights for a current user. Field 301 (or a separate field) may optionally also contain the link(s) 303 to be employed in initiating either display of information regarding acquisition of the requisite digital rights management module and access rights or actual acquisition of such module and access rights, or the actual information to be displayed. Content item 300 may also contain an access control list 304 of users authorized to access the respective instance or copy of the content item 300.

In an alternative embodiment, a protected content registry 305 accessible to the content access system 100 may contain a table 306 identifying, based on file type (e.g., file extension), the digital rights management system employed to protect a particular group of content items and the links necessary to obtain the appropriate digital rights management module. Registry 305 may also contain a table 307 identifying specific content items and associated user for which access is authorized (and for what periods access is authorized). Registry 305 may be maintained on content access device 100, within the authorized domain for the user of content access device 100, on a system remotely accessible to content access device 100, or in some combination of those locations, including by duplicate and/or partial copies at various locations.

In still other embodiments of the present invention, portions of the structure depicted for a protected content item 300 and for registry 305 may be combined. In addition, distribution and/or duplication of the information described between the protected content item and a registry (centralized or distributed) may be employed. Moreover, those skilled in the art will recognize that the exemplary structures shown may be suitably implemented in either data files or data communications packets.

FIG. 4 is a high level flow chart for a process of generating user interface display content for a content access system within which protected content items are identified and information relating to such items is conveyed by icons according to one embodiment of the present invention. The process 400 begins with receipt of a display request (step 401). The set of content items to be displayed is first determined (step 402), then protected content items are identified (step 403). Each protected content item is selected in turn and the associated digital rights management system is identified (step 404), the availability of the requisite digital rights management system is determined (step 405), and the requesting user's access rights to the item are determined (step 406). As long as individual protected content items remain to be processed (step 407). A display containing text or images (or both) representing the content items, together with icons as necessary to identify individual protected content items, the digital rights management system protecting the respective items, availability of digital rights management module(s) for accessing the protected content items, and the user's access rights, is then generated (step 408). If one of the icons is actuated (step 409), the appropriate information is displayed or download of the requisite digital rights management module and/or acquisition of access rights is initiated (step 410).

Only a few content players currently use digital rights management functionality, such as Windows Media Player from Microsoft Corporation. Moreover, such content players generally only handle content protected by one specific digital rights management system, and therefore do not show information about the digital rights management system or access rights in a content list. In the present invention, indication is given of which of a plurality of digital rights management systems is employed to protect each content item, together with availability of a module for accessing content protected by such a system and the user's rights, if any, to access the content item.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links and frames or packets.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

1. A display (200) of content items, comprising:
a displayed set (201) of display items (201a, 201b, 201c) each representing one of a plurality of protected content items including at least one content item protected by a first digital rights management system and at least an other one content item protected by a second digital rights management system; and
one or more icons (203, 204, 205) associated with a display item (201a, 201b, 201c) for each protected content item within the set 201, the one or more icons (203,204,205) at least one of
identifying a digital rights management system protecting the respective protected content item (201a, 201b, 201c),
indicating accessibility to a user of a digital rights management access module for accessing the respective protected content item (201a, 201b, 201c), and
indicating rights of the user to access the respective protected content item (201a, 201b, 201c).

2. The display (200) according to claim 1, wherein the one or more icons (203, 204, 205) identify a digital rights management system protecting the respective protected content item (201a, 201b, 201c), indicate accessibility to the user of the digital rights management access module for accessing the respective protected content item (201a, 201b, 201c), and indicate rights of the user to access the respective protected content item (201a, 201b, 201c).

3. The display (200) according to claim 1, wherein the one or more icons (203, 204, 205) associated with the display item (201a, 201b, 201c) for each protected content item within the set (201) identify a digital rights management system protecting the respective protected content item (201a, 201b, 201c), the icons including a first icon (204) associated with the display item (201a) for the one content item and indicating that the one content item is protected by the first digital rights management system and a second icon (204) associated with the display item (201b) for the other one content item and indicating that the other one content item is protected by the second digital rights management system.

4. The display (200) according to claim 1, wherein the one or more icons (203, 204, 205) associated with the display item 201a-201c for each protected content item within the set (201) indicate accessibility to a user of the digital rights management access module for accessing the respective protected content item, a first appearance of the one or more icons indicating that the digital rights management access module is accessible to the user and a second appearance of the one or more icons indicating that the digital rights management access module is not accessible to the user.

5. The display (200) according to claim 4, wherein the second appearance of the one or more icons (203, 204, 205) comprises a negation image superimposed on the first appearance of the one or more icons (203, 204, 205).

6. The display (200) according to claim 1, wherein the one or more icons (203, 204,205) associated with the display item (201a, 201b, 201c) for each protected content item within the set (201) indicate rights of the user to access the respective protected content item, a first appearance of the one or more icons (205) indicating that the user is entitled to access the respective protected content item and a second appearance of the one or more icons (205) indicating that the user is not entitled to access the respective content item.

7. The display (200) according to claim 1, wherein at least some of the one or more icons (203, 204, 205) further comprise user controls (a) enabling selective linking to or display of information regarding either acquisition of a digital rights management access module for accessing the respective protected content item or acquisition of rights to access the respective protected content item, (b) initiating acquisition of either the digital rights management module or the access rights, or (c) initiating operation of the digital rights management module.

8. A content access system (100) including the display (200) according to claim 1, the content access system (100) further comprising:
a display (101) on which the set (201) of display items and the one or more icons (203, 204, 205) are displayed;
a control sub-system (103) producing display of the set (201) of display items and the one or more icons (203, 204, 205) on the display (101); and
one or more user input mechanisms (102) enabling a user to select either a display item (201a, 201b, 201c) within the set (201) of display items or one of the one or more icons (203, 204, 205).

9. A software program product comprising machine usable instructions for generating the display (200) according to claim 1.

10. A signal comprising machine usable data representing the display (200) according to claim 1.

11. A display method (400), comprising:
displaying a set (201) of display items each representing one of a plurality of protected content items including at least one content item protected by a first digital rights management system and at least an other one content item protected by a second digital rights management system; and
displaying one or more icons (203, 204, 205) in association with a display item (201a, 201b, 201c) for each protected content item within the list, the one or more icons (203, 204, 205) at least one of
identifying a digital rights management system protecting the respective protected content item,
indicating accessibility to a user of a digital rights management access module for accessing the respective protected content item, and
indicating rights of the user to access the respective protected content item.

12. The method (400) according to claim 11, wherein the one or more icons )203, 204, 205) identify a digital rights management system protecting the respective protected content item, indicate accessibility to the user of the digital rights management access module for accessing the respective protected content item, and indicate rights of the user to access the respective protected content item.

13. The method (400) according to claim 11, wherein the one or more icons 203-205 associated with the display item (201a, 201b, 201c) for each protected content item within the set (201) identify a digital rights management system protecting the respective protected content item (201a, 201b, 201c), the icons (203, 204, 205) including a first icon (204) associated with the display item for the one content item and indicating that the one content item is protected by the first digital rights management system and a second icon (204) associated with the display item for the other one content item and indicating that the other one content item is protected by the second digital rights management system.

14. The method (400) according to claim 11, wherein the one or more icons (203, 204, 205) associated with the display item (201a, 201b, 201c) for each protected content item within the set (201) indicate accessibility to a user of the digital rights management access module for accessing the respective protected content item, a first appearance of the one or more icons indicating that the digital rights management access module is accessible to the user and a second appearance of the one or more icons indicating that the digital rights management access module is not accessible to the user.

15. The method (400) according to claim 14, wherein the second appearance of the one or more icons (203, 204, 205) comprises a negation image superimposed on the first appearance of the one or more icons (203, 204, 205).

16. The method (400) according to claim 11, wherein the one or more icons (203, 204, 205) associated with the display item (201a, 201b, 201c) for each protected content item within the set indicate rights of the user to access the respective protected content item, a first appearance of the one or more icons (203, 204, 205) indicating that the user is entitled to access the respective protected content item and a second appearance of the one or more icons (203, 204, 205) indicating that the user is not entitled to access the respective protected content item.

17. The method (400) according to claim 11, wherein at least some of the one or more icons (203, 204, 205) further comprise user controls (a) enabling selective linking to or display of information regarding either acquisition of the digital rights management access module for accessing the respective protected content item or acquisition of rights to access the respective protected content item.

18. A user interface (200) comprising:
display items (201a, 201b, 201c) representing a set (201) of content items displayed on a display (101), the content items including one or more items protected by at least one of a plurality of digital rights management systems; and
icons (203, 204, 205) displayed on the display (101) in association with at least display items (201a, 201b, 201c) for those content items within the set that are protected by a digital rights management system, the icons (203, 204, 205) indicating protection of the protected content items by a digital rights management system and, for each protected content item, identifying which of the plurality of digital rights management systems protects the respective protected content item and whether an access module for the identified digital rights management system is accessible for execution.

19. The user interface (200) according to claim 18, wherein the icons (203, 204, 205) further indicate, for each protected content item, whether a current user has access entitlements for the respective protected content item.

20. The user interface (200) according to claim 19, wherein the icons (203, 204, 205) further comprise user controls for (a) accessing information regarding either retrieval of an access module for the identified digital rights management system or acquisition of access entitlements for the respective protected content items, or (b) initiating either retrieval of an access module for the identified digital rights management system or acquisition of access
entitlements for the respective protected content items.
